(19) United States
(12) Patent Application Publication
(10) Pub. No.: US 2013/0044080 A1
(43) Pub. Date: Feb. 21, 2013

(54) DUAL-VIEW DISPLAY DEVICE OPERATING METHOD

(71) Applicant: HOLY STONE ENTERPRISE CO., LTD., Taipei City (TW)

(72) Inventor: Chiu-Lin CHIANG, Taipei City (TW)

(73) Assignee: HOLY STONE ENTERPRISE CO., LTD., Taipei City (TW)

(21) Appl. No.: 13/655,494

(22) Filed: Oct. 19, 2012

Related U.S. Application Data
(63) Continuation-in-part of application No. 12/801,586, filed on Jun. 16, 2010.

(51) Int. Cl. G06F 3/041; G06F 3/042; G06F 3/044

(52) U.S. Cl. 345/174; 345/173

(57) ABSTRACT

A dual-view display device operating method for operating a dual-view display device that delivers different images to viewers at different sides and has multiple sensors in multiple sides thereof by: sensing the approaching of an object by the sensors to produce a heading value corresponding to the direction of the object, and then coupling and computing all received sensing signals from the sensors to produce an operating parameter for running an air gesture application procedure. Thus, the dual-view display device allows different users to execute different operating procedures on respectively viewed different video displays, saving the installation cost and enhancing operational convenience.

This application is a Continuation-In-Part of application Ser. No. 12/801,586, filed on Jun. 16, 2010, for which priority is claimed under 35 U.S.C. §120, the entire contents of which are hereby

incorporated by reference.

### BACKGROUND OF THE INVENTION

1. Field of the Invention

The present invention relates to a method of operating an electronic device and more particularly, to a dual-view display device operating method, which uses non-contact directional sensors to sense the direction of the object approaching one of the video frames of the dual-view display device, enabling a user to control the operation of the respective video frame under watching, enhancing the convenience of use.

2. Description of the Related Art

Following fast development of the modern technology, many different kinds of displays, such as LCD (liquid crystal display) and OLED (organic light emitting diode) have entered into our daily life. Conventional displays are single view displays that deliver one single image to viewers viewing in different angles of view. When different users wish to view different image contents, a software or hardware is necessary for switching the display. Nowadays, dual-view displays have been created to deliver images to viewers in different angles of view. A dual-view display TV solves the TV channel squabble.

When one user views a dual-view display devise in a first angle of view, a first video frame is shown on the display panel. When another user views the same dual-view display device in a second angle of view at the same time, a second video frame is shown on the display panel. A dual-view display device has switching means that functions as a parallax barrier that separates the direction of light from each pixel of the LCD panel into two directions. Thus, people on the left and on the right can see different view frames displayed on the display panel of the dual-view display device. Taiwan Publication No. 200919395 discloses a similar design.

When using a dual-view display device in a car, the driver and the passenger at the front passenger seat can enjoy different image contents displayed on the display panel of the dual-view display device m different angles of view. For example, the driver on the left can view a first video frame relating navigation parameters (for example, GPS navigation view frame), the passenger on the right can view a second video frame (for example, TV program). Thus, the driver and passengers in a car can view different image contents from one same display panel.

Further, following the development of non-mechanical control technology, such as roach control technology, a user can loach the display panel to achieve a click function. This touch control technology eliminates an extra mechanical switching structure, saving the cost. Employing touch control technology to display panels saves hardware cost and enhances use convenience. However, using touch control technology in a regular dual-view display device may encounter touch judgment confusion, i.e., the dual-view display device cannot judge which user made the touch for controlling which video frame. Thus, the dual-view display device cannot determine the relative application program. To avoid this problem, extra mechanical buttons shall be installed m the dual-view display device, or an extra remote control device shall be used for selection control. However, installing extra mechanical buttons or using an extra remote control device complicates the structural design and relatively increases the cost.

US Publication No. 2009/0013261 A1 discloses a display apparatus that is capable of, even when an icon displayed to a viewer who is positioned in a different view angle direction is erroneously operated, preventing an execution of processing concerning the wrong operation. As shown by the reference numeral M, when a viewer X who is positioned in a predetermined view angle direction (left side) erroneously operates an icon Y displayed to a viewer Y who is positioned in a different view angle direction (right side) from that direction, an icon display control portion displays dialogs for requesting an input as to whether or not processing concerning the operated icon is required on display screens. Based on an input operation in the dialog displayed in the view angle direction, of the icon Y, the icon execution control portion performs a control of the execution of the processing concerning the icon.

According to the aforesaid prior art design, when a viewer positioning in one view angle direction (left side) erroneously operates an icon displayed to a viewer positioning in a different view angle direction, an icon display control portion will display dialogs for requesting an input as to whether or not processing concerning the operated icon is required on display screens. This method avoids errors, however, the action to confirm the procedure complicates the operation. For example, if the person sitting in the front passenger seat erroneously operates an icon displayed to the driver, the driver may be unable to make confirmation immediately and the processing must he delayed. If the driver is distracted to make confirmation at this time, a traffic accident may occur. Further, if the driver is watching a GPS navigation picture and the passenger in the front passenger seat is watching a TV program, the passenger cannot see the GPS navigation picture. In this case, the passenger dates not to make an input operation in the dialog displayed in the view angle direction of the icon displayed to the driver, and can simply wait till the driver is free to handle the case. During this waiting time, the passenger may be unable to watch the TV program. Therefore, this conventional design is still not satisfactory in function.

Therefore, it is desirable to provide a dual-view display device operating method, which eliminates the aforesaid drawbacks.

### SUMMARY OF THE INVENTION

The present invention has been accomplished under the circumstances in view. It is one object of the present invention to provide a dual-view display device operating method, which allows control of different video frames of the display panel of a dual-view display device in different angles of view by different persons at different sides without any mechanical buttons or remote control means. It is another object of the present invention to provide a dual-view display device operating method, which enhances the flexibility in use of a dual-view display device.

To achieve these and other objects of the present invention, a dual-view display device operating method, which enables a user to operate a dual-view display device having at least one non-contact directional sensor disposed in each of two opposing sides thereof by: approaching an object to the sensor at one of two opposing sides corresponding to one of two video frames of the display panel for causing the sensor to provide a sensing signal for producing a heading value, and then computing all received sensing signals from all the sensors to produce an operating parameter (that contains the data of, but not Limited to, touch location, object moving direction, object distance and object moving speed) for running an application procedure. Thus, different users can operate different video frames of the display panel without through any mechanical buttons or remote control means, saving the hardware installation cost and enhancing the operational flexibility.

Further, when the approaching object touches the touchscreen of the display panel after the object has been sensed by one non-contact directional sensor in one side of the dual-view display device to provide a sensing signal containing a heading value corresponding to the direction of the sensed object for the selection of the respective application procedure for controlling the respective video frame of the display panel, it couples the heading value and the touch location thus obtained, and then runs a touch control application procedure.

Further, if the approaching object does not touch the display panel after having been sensed by one non-contact directional sensor in one side of the dual-view display device to provide a sensing signal containing a heading value, it determines the moving direction and moving speed of the continuously sensed object, and then couples and computes all sensing signals to produce an operating parameter, and then runs an air gesture application procedure subject to the operating parameter. Thus, the invention achieves versatile control.

### BRIEF DESCRIPTION OF THE DRAWINGS

FIG. 1 is a flow chart of a dual-view display device operating method in accordance with a first embodiment of the present invention.

FIG. 2 is a schematic applied view of the first embodiment of the present invention (I).

FIG. 3 is a schematic applied view of the first embodiment of the present invention (II).

FIG. 4 is a circuit block diagram of the present invention.

FIG. 5 is a flow chart of a dual-view display device operating method in accordance with a second embodiment of the present invention (I).

FIG. 6 is a flow chart of a dual-view display device operating method in accordance with a second embodiment of the present invention (II).

FIG. 7 is a schematic applied view of the second embodiment of the present invention.

### DETAILED DESCRIPTION OF THE PREFERRED EMBODIMENT

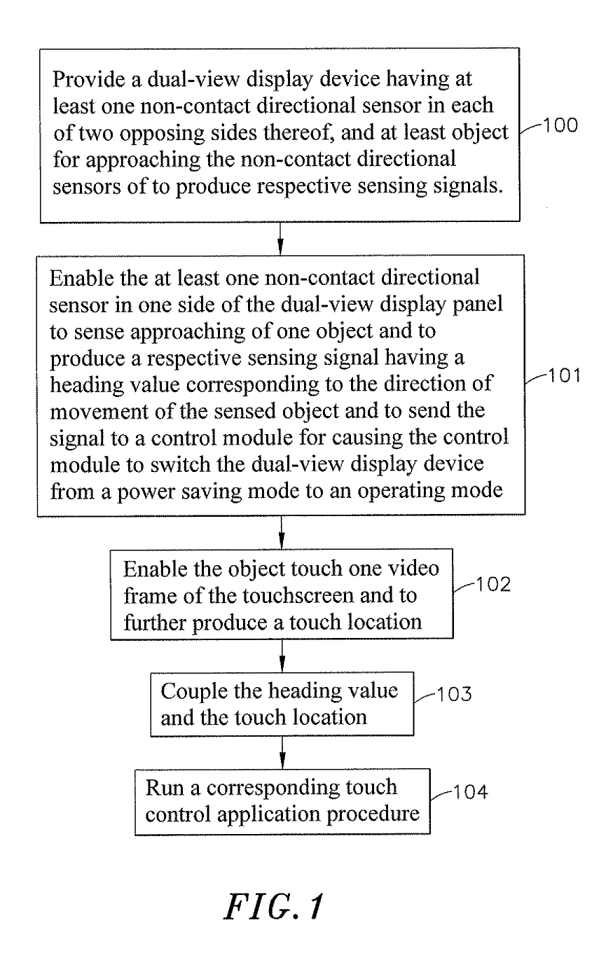

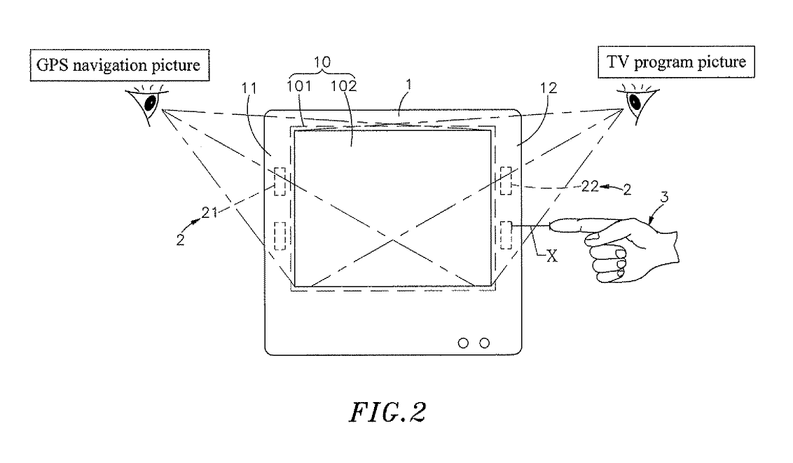

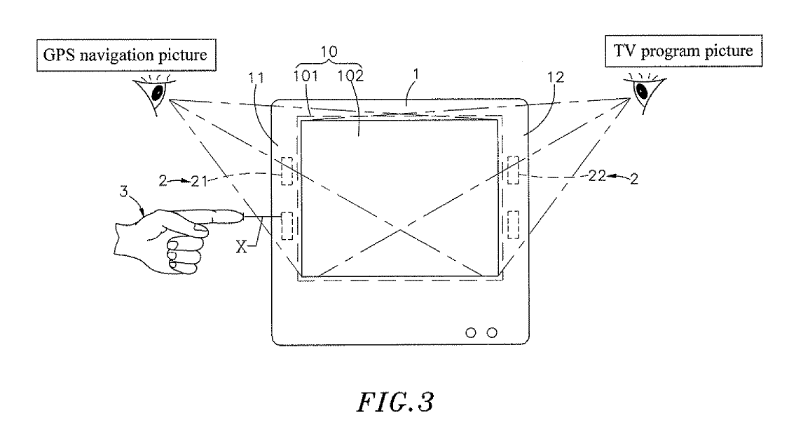

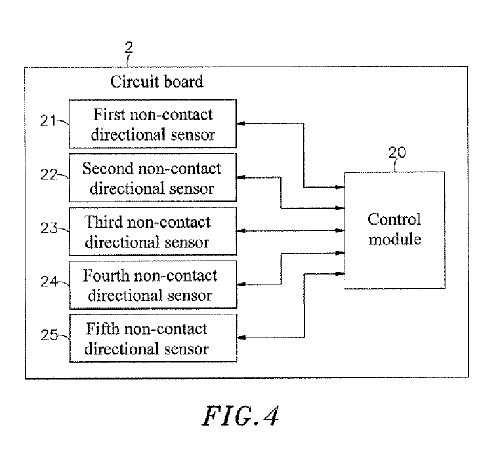

Referring to FIGS. 1, 2, 3 and 4, a dual-view display device operating method for use with a dual-view display device 1 in accordance with a first embodiment of the present invention is shown. According to this first embodiment, the dual-view display device 1 comprises a display panel 10. The display panel 10 comprises a dual-view display 101 and a touchscreen 102 at the front side of the dual-view display 101. Two opposing sides of the display panel 10 are defined as the first side 11 and the second side 12. The dual-view display device 1 further comprises at least one first non-contact directional sensor 21 installed in the first side 11, and at least one second non-contact directional sensor 22 installed in the second side 12. The first and second non-contact directional sensors 21;22 can be capacitive sensors or infrared sensors. Exemplars of capacitive type non-contact directional sensors can be seen in U.S. Pat. Nos. 7,498,749; 7,443,101; 7,336,037.

The dual-view display 101 of the display panel 10 of the dual-view display device 1 delivers different images to viewers on the right and left respectively. For example, the dual-view display device 1 can be used in a car so that one person in the car can see a first video frame (for example, GPS navigation map) on the dual-view display 101 of the display panel 10 in a first angle of view, another person in the car can view a second video frame (for example, TV program) on the dual-view display 101 of the display panel 10 in a second angle of view. In this case, the first angle of view is defined to be at the first side 11 of the dual-view display device 1; the second angle of view is defined to be at the second side 12 of the dual-view display device 1. Thus, different users can operate the dual-view display device 1 from different sides to control the respective view frames.

The dual-view display device operating method in accordance with the first embodiment of the present invention includes the steps of:

(100) Provide a dual-view display device 1 comprising a dual-view display panel 10 that comprises a dual-view display 101, a touchscreen 102 at the front side of the dual-view display 101 and at least one non-contact directional sensor disposed in each of two opposing sides thereof, and at least one object 3 for approaching the non-contact directional sensors of the dual-view display panel 10 to produce respective sensing signals.

(101) Enable the at least one non-contact directional sensor in one side of the dual-view display panel 10 to sense approaching of one said object 3 and to produce a respective sensing signal having a heading value corresponding to the direction of movement of the sensed object and to send the sensed signal to a control module 20, causing the control module 20 to switch the dual-view display device 1 from a power saving mode to an operating mode.

(102) Enable the object 3 to touch one video frame of the touchscreen 102 of the dual-view display panel 10 to produce a touch location.

(103) Couple the heading value and the touch location; and

(104) Run a corresponding touch control application procedure.

According to this embodiment, a first video frame and a second video frame can he seen on the dual-view display 101 of the display panel 10 of the dual-view display 1 in the first angle of view at the first side 11 of the dual-view display device 1 and in the second angle of view at the second side 12 of the dual-view display device 1 respectively. When one object 3, for example, a first user's finger enters a range X for example, within 10˜25 cm from, the first side 11, the first non-contact directional sensor 21 senses the presence of the first user's finger and then provides a sensing signal containing a corresponding heading value relative to the direction of the approaching object 3. The first non-contact directional sensor 21 is electrically connected to the control module 20 at the circuit hoard 2 in the dual-view display device 1. Subject to the sensing signal produced by the first non-contact directional sensor 21, the control module 20 judges that the approaching object 3 is at the first side 11 of the dual-view display device 1. Relatively, when another object 3, for example, a second user's linger enters a range X, for example, within 10˜25 cm from the second side 12, the second non-contact directional sensor 22 senses the presence of the second user's finger and then provides a sensing signal for producing a corresponding heading value relative to the direction of the approaching object 3. The second non-contact directional sensor 22 is electrically connected to the control module 20 at the circuit board 2 in the dual-view display device 1. Subject to the sensing signal produced by the second non-contact directional sensor 22, the control module 20 judges that the approaching object 3 is at the second side 12 of the dual-view display device 1. Thus, the control module 20 accurately judges the direction of an approaching object 3 subject to the heading value produced, and then stores the heading value in a built-in memory, or an external memory that is electrically connected to the control module 20.

When going to control a further function of one of the two video frames of the display panel 10 of the dual-view display device 1, the approaching object 3 must touch the surface of the touchscreen 102 of the display panel 10. When the object 3 touches the touchscreen 102 of the display panel 10, an operating parameter of touch signal (for example, but not limited to, touch location, object moving direction, distance between the object and the respective sensor, object velocity) is produced and transmitted to the control module 20 so that the control, module 20 can determine the touch location, and then couple the heading value and the touch location, and then run a touch control application procedure subject to the coupling result.

For example, a user in the driver's seat in a car can see a GPS navigation map displayed on the dual-view display 101 of the display panel 10 in the first angle of view. If the driver of the car wishes to zoom in one particular spot of the GPS navigation map displayed on the dual-view display 101 of the display panel 10, the driver can move one finger into the sensing range X of the first non-contact directional sensor 21 in the first side 11 of the dual-view display device 1. At this time, the first non-contact directional sensor 21 senses the presence of the driver's finger, and then provides a sensing signal to the control module 20. Upon receipt of the sensing signal received from the first non-contact directional sensor 21, the control module 20 analyzes the received sensing signal and produces a corresponding heading value, and then stores the heading value. When the driver's finger touches the display panel 10, the control module 20 couples the heading value and the touch location, and then run an application procedure of the GPS navigation software program subject to the data of the coupling result. On the other hand, another user in the assistant driver seat in the car can see a TV program displayed on the dual-view display 101 of the display panel 10 in the second angle of view. If the assistant driver of the car wishes to select TV channels, the assistant driver can move one finger into the sensing range X of the second non-contact directional, sensor 22 in the second side 12 of the dual-view display device 1. At this time, the second non-contact directional sensor 22 senses the presence of the assistant driver's finger, and then provides a sensing signal to the control module 20. Upon receipt, of the sensing signal received from the second non-contact directional sensor 22, the control module 20 analyzes the received sensing signal and produces a corresponding heading value, and then stores the heading value. When the assistant driver's finger touches a next channel selection button on the video frame displayed on the dual-view display 101 of the display panel 10, the control module 20 couples the heading value and the touch location, and then run an application procedure of the TV player software program subject to the data of the coupling result. Thus, different users can watch different video frames displayed on the dual-view display 101 of the display panel 10 at the same time, and then touch the touchscreen 102 of the display panel 10 to control different, video frames for different functions directly without through any mechanical button or remote control means. Thus, the invention effectively reduces hardware installation cost.

Subject to the aforesaid structural design and operating methods, the display panel 10 can deliver different images to viewers in different directions. Through the respective sensing direction of the first non-contact directional sensors 21 and second non-contact directional sensors 22 to determine which user touches the touchscreen 102, one user can simply run setting, adjustment, switching and/or other related application procedures on the picture under watching without affecting the other picture watching by other users. Thus, different images from different views can be separately delivered and operated, enhancing convenience of use. Further, except for in-vehicle and wall-mount applications to deliver different images to viewers in different directions, the dual-view display device 1 can also be configured to provide multiple views in different directions and equipped with multiple non-contact directional sensors in multiple sides thereof, and mounted at the center of the top of a table in a public place (restaurant, shop, department store, etc.) for enabling multiple persons around the table to watch and control, different displays, saving much installation space and cost. Further, when multiple persons operate the dual-view display device, the invention eliminates the problem of frequently jumping out of the dialog box to interfere with watching videos and the problem of repeatedly touching the touchscreen by different users to pop out different dialog boxes for displaying different videos as seen in conventional technologies. Thus, the dual-view display device of the invention is smooth and convenient in use.

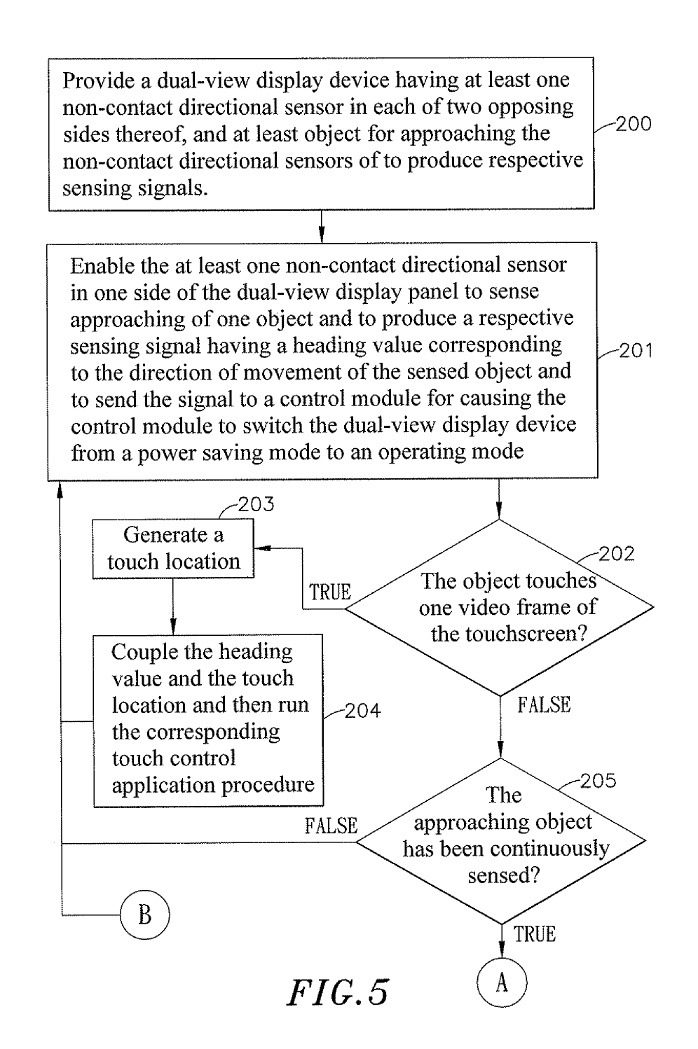

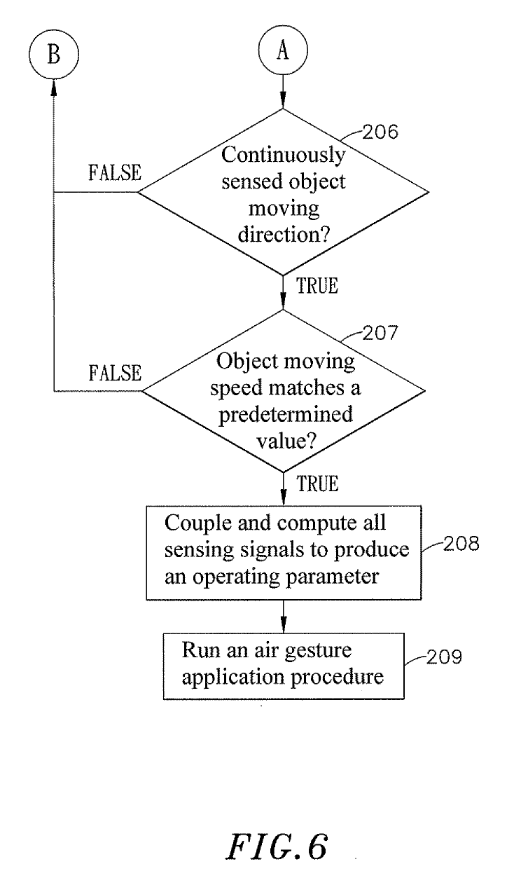

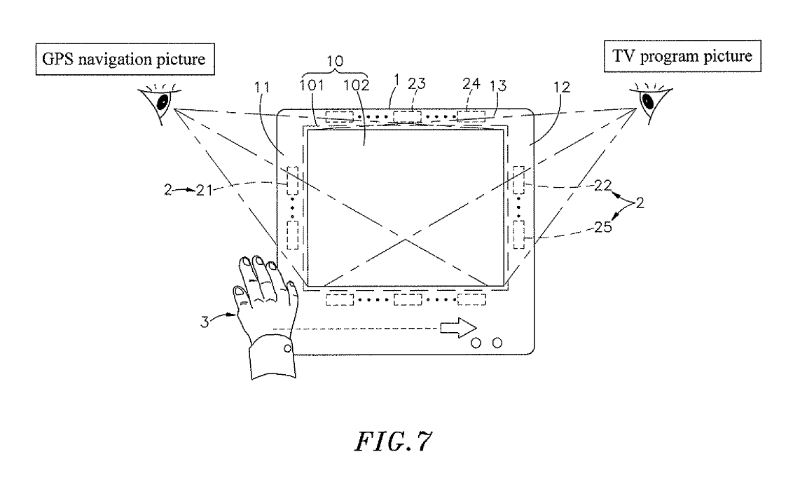

FIGS. 5 and 6 show a dual-view display device operating method used in a dual-view display device 1 in accordance with a second embodiment of the present invention, and FIG. 7 is a schematic applied view of the second embodiment. According to this second embodiment, the dual-view display device 1 comprises a display panel 10 defining opposing first side 11 and second side 12, at least one first non-contact directional sensor 21 installed in the first side 11 of the display panel 10 and at least one second non-contact directional sensor 22 installed in the second side 12 of the display panel 10. When an object 3 approaches the first side 11 or second side 12 of the display panel 10, a corresponding application procedure is performed in the same manner as the aforesaid first embodiment.

This second embodiment has an air gesture recognition function so that one user at either of two opposite sides relative to the dual-view display device 1 can control one respective video frame of the display panel 10 without direct contact. The dual-view display device operating method according to this second embodiment comprises the steps of:

(200) Provide a dual-view display device 1 comprising a dual-view display panel 10 that comprises a dual-view display 101, a touchscreen 102 at the front side of the dual-view display 101 and at least one non-contact directional sensor disposed in each of two opposing sides thereof, and at least one object 3 for approaching the non-directional sensors of the dual-view display panel 10 to produce respective sensing signals;

(201) Enable the at least one non-contact directional sensor in one side of the dual-view display panel 10 to sense approaching of one said object 3 and to produce a respective sensing signal having a heading value corresponding to the direction of movement of the sensed object 3 and then to send the sensed signal to a control module 20, causing the control module 20 to switch the dual-view display device 1 from a power saving mode to an operating mode.

(202) Determine whether or not the approaching object 3 has touched one video frame of the touchscreen 102 of the dual-view display panel 10? And then proceed to step (203) if yes, or step (205) if not.

(203) Generate a touch location.

(204) Couple the heading value and the touch location, and then run a corresponding touch control application procedure, and then return to step (201).

(205) Determine whether or not the approaching object 3 has been continuously sensed? And then proceed to step (206) if yes, or return to step (201) if not.

(206) Determine whether or not the moving direction of the continuously sensed object 3 matches a predetermined value? And then proceed to step (207) if yes, or return to step (201) if not.

(207) Determine whether or not the moving speed of the continuously sensed object 3 matches a predetermined value? And then proceed to step (208) if yes, or return to step (201) if not.

(208) Couple and compute all sensing signals to produce an operating parameter.

(209) Run an air gesture application procedure.

According to this second embodiment, a first video frame and a second video frame can be seen on the dual-view display 101 of the display panel 10 of the dual-view display 1 in the first angle of view corresponding to the first side 11 of the dual-view display device 1 and in the second angle of view corresponding to the second side 12 of the dual-view display device 1 respectively. When one object 3, for example, a first user's finger enters a range X relative to the first side 11, the first non-contact directional sensor 21 senses the presence of the first user's finger and then provides a sensing signal, containing a corresponding heading value-relative to the direction, of the approaching object 3. Subject to the sensing signal produced by the first non-contact directional sensor 21, the control module 28 judges that the approaching object 3 is at the first side 11 of the dual-view display device 1. Relatively, when another object 3, for example, a second user's finger enters a range X relative to the second side 12, the second non-contact directional sensor 22 senses the presence of the second user's finger and then provides a sensing signal for producing a corresponding heading value relative to the direction of the approaching object 3. Subject to the sensing signal produced by the second non-contact directional sensor 22, the control module 20 judges that the approaching object 3 is at the second side 12 of the dual-view display device 1. Thus, the control module 20 accurately judges the direction of an approaching object 3 subject to the heading value produced, and then stores the heading value in a built-in memory, or an external memory that is electrically connected to the control module 20.

Thereafter, the control module 20 determines whether or not the approaching object 3 has touched the surface of the touchscreen 102 of the display panel 10 within a predetermined time period? If the approaching object 3 does not touch the surface of the touchscreen 102 of the display panel 10, it is determined that the user is making an air gesture control, i.e. the dual-view display device 1 will enter an air gesture recognition mode. Under this air gesture recognition mode, the first non-contact directional sensor 21 at the first side 11 and the second non-contact directional sensor 22 at the second side 12 of the dual-view display device 1 are used to recognize an air gesture. However, additional non-contact directional sensors may be mounted in the other sides adjacent to the first side and the second side, for example, a third non-contact directional sensor 23 and a fourth non-contact directional sensor 24 in a third side 13 and the second non-contact directional sensor 22 and a fifth non-contact directional sensor 25 in the second side 12. These non-contact directional sensors are activated to sense the movement of the approaching object 3 and to further produce an operating parameter through a computation. The sensing signal, produced by each activated sensor comprises the data of, but not limited to, distance, direction and speed. The computation is made subject to the formula of:

Ag=S₁{f(d), f(t)}·S₂{f(d), f(t)}. . . S_{y}{f(d), f(t)}

where:

Ag (air gesture operation)=the operating parameter;

S=non-contact directional sensor;

S₁=the first non-contact directional sensor;

S₂=the second non-contact directional sensor;

S_{y}=the y^{th} non-contact directional sensor;

f(d)=the distance between the sensed object 3 and the non-contact directional sensor sensing the object 3;

f(t)=the moving time from one non-contact directional sensor to a next non-contact directional sensor.

Calculation of the moving time is made by: defining the time of the first detection of the object 3 to be the first time point t₁ and the time of the last detection of the object 3 to he the second time point t₂, and then obtaining the moving time by the formula of t₂−t₁. Thus, the control module 20 can couple and analyze the sensing signals received from the non-contact directional sensors to produce an operating parameter. According to the present preferred embodiment, the operating parameter comprises the data of, but not limited to, the moving direction of the sensed object 3, the distance between the sensed object 3 and the respective non-contact directional sensor, and the moving speed of the sensed object 3. Subject to the operating parameter thus produced, an air gesture application program is performed.

In this second embodiment the arrangement of the third non-contact directional sensor 23 and fourth non-contact directional sensor 24 in the third side 13 and the second non-contact directional sensor 22 and fifth non-contact directional sensor 25 in the second side 12 is simply an example of the present invention. However, this example is simply for the purpose of illustration only hut not for use as a limitation. According to the aforesaid operation flow, the control module 20 determines whether or not the object 3 has been continuously sensed by the third non-contact directional sensor 23 and fourth non-contact directional sensor 24, or the second non-contact directional sensor 22 and fifth non-contact directional sensor 25 within a predetermined time period? If the object 3 is continuously sensed by, for example, the third non-contact directional sensor 23 and fourth non-contact directional sensor 24 within the predetermined time period, the control module 20 will receive sensing signals Ag=S₃{f(d), f(t)}·S₄{f(d), f(t)}. Thereafter, the control module 20 determines the moving direction of the object 3 subject to the sequence of the sensing signals received. Subject to the aforesaid calculation formula, it is known that the object 3 moves from the left toward the right. Thereafter, the distance between the object 3 and the third non-contact directional sensor 23 and the distance between the object 3 and the fourth non-contact directional sensor 24 are determined subject to f(d). Thereafter, subject to f(t), the moving speed of the object 3 is determined to be in conformity with the set value or not. For example, if the time period from the first time point t₁ to the second time point t₂ is 5˜6 seconds and the distances between the object 3 and the second non-contact directional, sensor 22 and fifth non-contact directional sensor 25 are equal and all to be 5 cm, it is determined to be an operation for volume control.

On the other hand, when the control module 20 received sensing signals from the second non-contact directional sensor 22 and fifth non-contact directional sensor 25 within the predetermined time period, the lime period from the first time point t₁ to the second time point t₂ during movement of the object 3 is shorter than one second, and the distances between the object 3 and the third non-contact directional sensor 23 and fourth non-contact directional sensor 34 are equal and ail to be 5 cm, thus it is determined to be a command from the user in the front passenger seat for turning to the nest page. However, it is to be understood that the above explanation is simply an example of the present invention and shall not be considered to be limitations of the invention.

According to the present invention, the dual-view display device 1 has stored therein multiple operating parameters, for example, the parameter for next page operation control or the parameter for volume control. Further, the invention uses the control module 20 to receive sensing signals from the non-contact directional sensors, and uses a formula to compute the content of the sensing signals. If the content of one sensing signal obtained through computation matches one pre-set operating parameter, the control module 20 will immediately execute the corresponding application program and operating software procedure. Thus, different users viewing different video frames of the dual-view display device 1 can input control signals into the dual-view display device 1 by touch, or by means of air gesture, enhancing operational flexibility.

Further, when one object 3 enters a predetermined range relative to the dual-view display device 1, the non-contact directional sensors will provide a respective sensing signal to the control module 20, causing the control module 20 to start up power supply for the other modules of the dual-view display device 1, waking up the other modules of the dual-view display device 1 from the standby mode into the operating mode. Thus, the dual-view display device 1 can be kept in the power saving mode when it is not operated.

In conclusion, the invention provides a dual-view display device operating method, which has advantages and features as follows:

1. The dual-view display device operating method of the present invention allows different users viewing different video frames of a dual-view display device to operate the respectively viewed video frames of the dual-view display device by touch control, or by air gesture without direct contact. The dual-view display device 1 has multiple sensors installed in multiple sides thereof. When a designated object 3 enters the sensing range of one non-contact directional sensor, the control module 20 of the dual-view display device 1 determines the sensing of the sensors to be a continuous sensing or not, and then determines whether or not the sensing signals of the non-contact directional sensors match predetermined values, for example, moving direction and moving speed, and then couples and analyzes all the received sensing signals to produce an operating parameter, and then runs an application procedure subject to the operating parameter. Thus, it is not necessary to install mechanical buttons in the dual-view display device 1, or to use a remote control device. Further, when one user operates one view frame of the dual-view display device 1 to execute one operating procedure, the other view frame of the dual-view display device keeps displaying without obstruction. Thus, the dual-view display device 1 uses one single display panel 10 to provide multiple video frames for viewing and operating by multiple viewers in different angles of view, saving the hardware installation cost and enhancing the convenience of use.

2. The operating method of the present invention includes a touch control operation mode and an air gesture operation mode. Upon sensing of the presence of an object 3, the object direction is determined, and then the application procedure to be performed is determined. Thereafter, it is determined whether or not the approaching object has touched the surface of the display panel 10? The corresponding touch control operating procedure will be performed when a touch control is determined. If the approaching object does not touch the display panel 10, it will enter the air gesture operating procedure. Thus, the invention provides the dual-view display device 1 with multiple control modes.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A dual-view display device operating method, comprising the steps of:
(a) providing a dual-view display device comprising a dual-view display panel, said dual-view display panel comprising a dual-view display, a touchscreen at a front side of said dual-view display and at least one non-contact directional sensor disposed in each of two opposing sides thereof, and at least one object for approaching one said non-contact directional sensor of said dual-view display panel to produce respective sensing signals;
(b) enabling one said non-contact directional sensor in one side of said dual-view display panel to sense the approaching of one said object and to produce a sensing signal containing a heading value corresponding to the direction of the sensed object;
(c) enabling the approaching object to touch said touchscreen of said dual-view display panel for causing said dual-view display panel to produce a touch location;
(d) coupling the heading value and the touch location thus obtained; and
(e) running a touch control application procedure.

2. The dual-view display device operating method as claimed in claim 1, wherein sensing the approaching of one said object in step (a) is achieved by means of the sensing operation of one said non-contact directional sensor to detect the presence of one said object within a predetermined range X.

3. The dual-view display device operating method as claimed in claim 1, wherein the heading value obtained in step (b) is determined subject to the location of the non-contact directional sensor in one side of said dual-view display panel that senses the approaching object.

4. The dual-view display device operating method as claimed in claim 1, wherein the non-contact directional sensors of said dual-view display device provided in step (a) are selected from the group of capacitive sensors and infrared sensors.

5. The dual-view display device operating method as claimed in claim 1, wherein when one said object is sensed by one said non-contact directional sensor in step (b), said dual-view display is switched from a power-saving mode to an operating mode.

6. A dual-view display device operating method, comprising the steps of:
(a) providing a dual-view display device comprising a dual-view display panel, said dual-view display panel comprising a dual-view display, a touchscreen at a front side of said dual-view display and at least one non-contact directional sensor disposed in each of two opposing sides thereof, and at least one object for approaching one said non-contact directional sensor of said dual-view display panel, to produce respective sensing signals;
(b) enabling one said non-contact directional sensor in one side of said dual-view display panel to sense approaching of one said object and to produce a respective sensing signal containing a heading value corresponding to the direction of movement of the sensed object;
(c) determining whether or not the approaching object has touched said touchscreen of said dual-view display panel, and then proceeding to step (d) if yes, or step (g) if not;
(d) generating a touch location;
(e) coupling the heading value and the touch location thus obtained, and then running a touch control application procedure, and then returning to step (a);
(f) determining whether or not the approaching object has been continuously sensed or not, and then proceeding to step (g) if yes, or returning to step (a) if not;
(g) determining whether or not the moving direction the continuously sensed object matches a predetermined value or not, and then proceeding to step (h) if yes, or returning to step (a) if not;
(h) determining whether or not the moving speed of the continuously sensed object matches a predetermined value or not, and then proceeding to step (i) if yes, or returning to step (a) if not;
(i) coupling and computing all sensing signals to produce an operating parameter; and
(j) running an air gesture application procedure.

7. The dual-view display device operating method as claimed in claim 6, wherein sensing the approaching of one said object in step (a) is achieved by means of the sensing operation of one said non-contact directional sensor to detect the presence of one said object within a predetermined range X.

8. The dual-view display device operating method as claimed in claim 6, wherein the non-contact directional sensors of said dual-view display device provided in step (a) are selected from the group of capacitive sensors and infrared sensors.

9. The dual-view display device .operating method, as claimed in claim 6, wherein the heading value obtained in step (b) is determined subject to the location of the non-contact directional sensor in said dual-view display panel that senses the approaching object.

10. The dual-view display device operating method as claimed in claim 6, wherein when one said object is sensed by one said non-contact directional sensor in step (b), said dual-view display is switched from a power-saving mode to an operating mode.
